(19) United States
(12) Patent Application Publication
(10) Pub. No.: US 2015/0161501 A1
(43) Pub. Date: Jun. 11, 2015

(54) CHIP CARD WITH CONTACTING THAT IS PASTY OR LIQUID AT ROOM TEMPERATURE

(71) Applicant: Morpho Cards GmbH, Flintbek (DE)

(72) Inventors: Thoralf Krull, Norderstedt (DE); Carsten Senge, Kiel (DE)

(73) Assignee: Morpho Cards GmbH, Flintbek (DE)

(21) Appl. No.: 14/412,155

(22) PCT Filed: Jul. 2, 2013
(86) PCT No.: PCT/EP2013/063899

§ 371 Date: Dec. 30, 2014

(30) Foreign Application Priority Data
Jul. 3, 2012 (DE) 10 2012 211 546.3

(51) Int. Cl. G06K 19/077

(52) U.S. Cl. CPC G06K 19/07745; G06K 19/077; G06K 19/0775

(57) ABSTRACT

The invention relates to a chip card, comprising a first electrical component part (102; 104) and a second electrical component part (106), wherein the first electrical component part and the second electrical component part are contacted with one another via an electrically conductive material (112), wherein the material (112) consists of a metal or a metal alloy, wherein the metal or the metal alloy is pasty or liquid at room temperature.

The invention relates to a chip card, and also to a method for producing a chip card.

Chip cards are typically produced by introducing for example component parts, for example chip modules, into a chip card body. Besides a module such as a chip module, a typical chip card also comprises further electrical components, such as an antenna or a battery. An electrically conductive connection between contacts of said module and the contacts of the further electrical component part is generally necessary for the operability of a chip card of this type. Here, this electrically conductive connection consists of at least two connectors, which, provided they are arranged in one plane, are spatially fully separated from one another in order to avoid a short circuit therebetween.

A method for producing a chip card by electrically conductive connection of a chip module to a chip card body is known from WO 2011/082765 A1, wherein the chip module is adhesively connected to the chip card body by means of a thermoplastic, electrically conductive elastomer material, and therefore the chip module is conductively connected to at least one electrical contact area of the chip card body.

DE69820684T2 discloses a chip card comprising a microcircuit, which is sunk into a card carrier and which comprises outlet tabs connected to interface elements formed by a terminal point and/or an antenna, wherein the connectors between the outlet tabs and the interface elements are produced using a conductive substance. The conductive substance applied by means of a syringe or the like has a low viscosity and remains resilient after application and polymerisation thereof and forms a belt. The terminal point or the antenna consists of a conductive substance that has low viscosity and is resilient, for example a polymer resin loaded with (inwardly) conductive particles.

FR2624284A1 discloses an electronic module, which is held in a recess in a chip card by means of liquid or viscous material.

DE19500925A1 discloses a chip card for contactless data transmission, which comprises a transmission module incorporated separately into the card body. This transmission module comprises an antenna in the form of at least one coil for inductive data and energy transmission and/or in the form of electrically conductive layers for capacitive data and energy transmission. For electrical coupling to the chip module, the transmission module comprises connector areas.

The object of the invention is to provide an improved chip card and an improved method for producing a chip card.

The objects forming the basis of the invention are achieved by the features in the independent claims. Preferred embodiments of the invention are specified in the dependent claims.

A chip card comprising a first electrical component part and a second electrical component part is created, wherein the first electrical component part and the second electrical component part are contacted with one another via an electrically conductive material, wherein the material consists of a metal or a metal alloy, wherein the metal or the metal alloy is pasty or liquid at room temperature.

Embodiments of the invention could have the advantage that the electrically conductive connection produced via the electrically conductive material ensures a high service life of the chip card, even under mechanical load of the chip card. The technical demands on the described electrically conductive connection are raised in particular in the case of high-quality chip cards, where a long service life is required. With use of chip cards, mechanical loads occur for example, since strong mechanical stresses can be initiated due to deflection, torsion and also different thermal coefficients of expansion of the materials used. Due to the described electrically conductive material, a robust and durable electrically conductive connection can be ensured between the contacts of the first electrical component part and of the second electrical component part, since mechanical stresses between said contacts and in the actual connection element are avoided due to the paste form or the liquid form of the electrically conductive material.

Since a metal or a metal alloy is used, a longevity of this electrically conductive material is also ensured. There may be no vaporisation within said period of the service life of a chip card (normally in the region of 10 years), and therefore the mechanical and electrical properties of the electrically conductive material used also do not change considerably due to the selection of a metal or a metal alloy. It can therefore be ensured over the entire service life of the chip card that the mechanical and electrical properties of the electrically conductive material and therefore key properties of the chip card remain unchanged.

On the whole, the use of electrically conductive material that, in the form of a metal or a metal alloy, is pasty or liquid at room temperature, provides a fatigue-proof, flexible connection option for the contact area of a first and second electrical component part, said connection being able to easily cope with mechanical loads that normally occur. This is of key importance in particular for the production of high-quality and durable chip cards, such as identification documents.

Within the scope of the present invention, a “pasty” electrically conductive material is understood to mean a material that is no longer free-flowing at room temperature, but is “spread-resistant” and yet still has a viscosity of such a level that it can adapt in a fatigue-proof manner in the event of a mechanical loading of the contacts of the first and second electrical component part and the resultant, modified relative position of the contacts of the electrical component parts. The term “pasty” could also be defined such that the viscosity of the material is less than 10⁶ mPa s.

In accordance with an embodiment of the invention, the chip card comprises a card body, wherein the electrically conductive material is enclosed by the card body and/or the first electrical component part and/or the second electrical component part. The enclosure ensures that a material loss caused by vaporisation over a long period of time is avoided, even in spite of a very low vapour pressure of the material. This also has the advantage that influences by external media or by moisture do not lead to a corrosive load of the electrically conductive material, and the electrical and mechanical properties of the electrically conductive material can thus be maintained practically constantly, even over a relatively long period of time. On the whole, a continuously resistant and age-resistant electrical contacting is produced due to the enclosure.

In accordance with an embodiment of the invention, the enclosure results at least in part from an adhesive bond. For example, the first electrical component part or the second electrical component part could be adhesively bonded to the card body, such that, after the adhesive bonding, the electrically conductive material is surrounded by the card body and the first or second electrical component part is enclosed. This therefore enables a simple production method, in which for example lamination and adhesive bonding processes selected in the prior art between the card body and electrical component parts can be used.

In accordance with an embodiment of the invention, the card body comprises a recess, wherein the electrically conductive material is received at least in part in the recess and the first component part and the second component part are arranged facing towards one another on mutually opposed sides of the recess. It is noted that “on mutually opposed sides of the recess” is to be understood such that not only is a direct mutually opposed arrangement of the component parts intended hereby, but it is also possible for the component parts to be arranged in a manner laterally offset from one another.

Due to the recess, a type of “guide” for the electrically conductive material is produced, such that, even in the event of thermal expansion or mechanical influence, said material remains in a predefined spatial region relative to the first and second component part. The electrically conductive material cannot therefore flow to any arbitrary locations in order to remain there permanently once the mechanical load or the thermal expansion has abated. Furthermore, the use of a recess on the card body could simplify a production of the described chip card. To this end, the chip card would have to be provided for example with its card body and the first electrical component part, and the electrically conductive material would then be metered into the recess. Alternatively, the card body could also be provided together with the electrically conductive material in order to then perform the contacting with the first and second electrical component part. This simplifies the production process of the chip card on the whole. In particular with the latter method, the material could be provided in a cooled state together with the card body (in order to prevent the electrically conductive material from flowing away), wherein the cooled state is selected such that the state of matter of the material is solid.

In accordance with an embodiment of the invention, the recess in the contacted state of the first component part and of the second component part is incompletely filled with the electrically conductive material. This could have the advantage that, in the case of a thermal expansion or in the case of an induction of a mechanical voltage from the outside, there is sufficient space for the electrically conductive material to spread within the recess. The mechanical force that acts on the contacts of the first electrical component part and of the second electrical component part via the electrically conductive material is thus minimised.

In accordance with an embodiment of the invention, the recess has a slot shape. The slot shape could have the advantage that it can be provided oriented in a specific direction with respect to the card body of the chip card. A chip card is typically rectangular, whereby a side length (longitudinal direction) of the chip card is greater than the other side length perpendicular hereto. Since the contact between the first and second electrical component part is normally produced in the longitudinal direction of the card, offset laterally with respect to one of the component parts, the space for the recess is reduced in this longitudinal direction. This minimises the space for an adhesive bond that is to be applied around the recess for the abovementioned seal. In this regard, there is little space in the direction parallel to this longer edge, and therefore a possible advantageous embodiment could be to select the direction of extension of the slot so as to be perpendicular to said longer edge. Therefore, instead of selecting merely a greater hole diameter (circular), which has a high spatial requirement in all directions, the component parts can be arranged relative to one another in an optimal manner by means of the slot shape.

In accordance with an embodiment of the invention, the electrically conductive material is free of organic compounds. It could thus be ensured that the mechanical and electrical properties of the electrically conductive material can be ensured in a practically unchanged manner, even over a long period of use. No ageing loss of the flowability of the material and also no age-induced decrease of the conductivity occur. In addition, the heat sensitivity of the electrically conductive material is minimised by the absence of organic compounds.

In this regard, reference is made for example to the negative properties of electrically conductive silicone material, which, particularly over the course of ageing, loses its initially pronounced resilient behaviour little by little. Due to excessively low restoring forces, such a material in particular would not be able, after a certain ageing process, to compensate for any enlargement of the contact spacing between the first and second component part caused by mechanical or thermal load. This could lead, in the case of chip cards, to an interruption of the contacts and therefore to a failure of the function of the chip card. Electrically conductive silicone material is also subject to ageing with regard to its intrinsic conductivity. Particularly in the temperature change or temperature shock test, a degradation occurs that is accompanied by a decrease of the conductivity of the connection.

In accordance with an embodiment of the invention, the first electrical component part comprises a meandering contact region, wherein the contacting between the first electrical component part and the second electrical component part is provided via the contact region. The embodiment of the contact region in the meander form has the advantage that the likelihood of the electrically conductive material coming into contact with the first electrical component part is maximised. The same is also true with regard to an embodiment of the contact region of the second electrical component part in meander form.

It is noted that the maximisation of the likelihood of good contacting between the first and the second electrical component part could also alternatively be maximised by forming the corresponding contact areas continuously with a large area. This requires a high material outlay however with regard to the contact areas, and therefore, in particular in the case of a mass production method, cost savings are possible here as a result of the use of a meandering contact region. In addition, the meander form enables the “wire” used for contacting to be applied directly to the card body. In particular, “electrical component part” in the case of an antenna and “wire” in the case of the contact region are identical. This simplifies the production of the chip card compared for example to etching methods, by means of which the antenna in the card body is produced.

In accordance with an embodiment of the invention, the first electrical component part and/or the second electrical component part comprises a chip module or a conductive track or an antenna or a switch or a display or a battery or a sensor.

In accordance with an embodiment of the invention, the contact between the first electrical component part and the second electrical component part in the contacted state results from an adhesion of the electrically conductive material to the contacts of the first electrical component part and of the second electrical component part. This has the advantage that an adhesively bonding connection is not necessary in order to ensure the contacts between the first and the second electrical component part via the electrically conductive material. Irrespective of an external mechanical influence, it is also continuously ensured that the electrically conductive material remains in contact with the first and second electrical component part.

In a further aspect, the invention relates to a method for producing a chip card, said method comprising the steps of providing an electrical component part in a chip card body and subsequently applying an electrically conductive material to the first electrical component part. The material consists of a metal or a metal alloy, wherein the metal or the metal alloy is pasty or liquid at room temperature. Lastly, a second electrical component part is brought into contact with the electrically conductive material, for example with simultaneous mechanical anchoring (adhesive bonding) of the element in the card body.

In accordance with an embodiment of the invention, the method further comprises an enclosure of the electrically conductive material.

In accordance with an embodiment of the invention, the electrically conductive material is applied by means of volumetric metering and/or a printing method and/or by the provision of a carrier with at least one recess, wherein the recess comprises the material, wherein the carrier is applied to the first electrical component part.

In particular, the volumetric metering has the advantage that a cost-effective application method can be used by dispensing.

In accordance with an embodiment of the invention, the first electrical component part of the chip card is provided on a card body, wherein the method further comprises a production of a recess in the card body, wherein the volumetric metering comprises a metering of the material into the recess. The electrically conductive material may therefore already be provided in a recess of a carrier and the carrier then applied to the first electrical component part. Alternatively, the electrical component part and the carrier are initially provided together. A recess is only then produced in the card body (provided a recess is not already provided), and the material is volumetrically metered into the recess already provided or to be produced.

In accordance with an embodiment of the invention, the electrically conductive material is applied in a solid state of matter of the material, this state being produced by cooling. This could simplify the application of the electrically conductive material, since, in particular in the case of liquid materials, a shifting of the electrically conductive material away from the contacts is avoided. The electrically conductive material can thus be brought into the contact region in a very target-oriented manner.

In accordance with an embodiment of the invention, the second electrical component part is brought into contact with the electrically conductive material in the solid state of matter of the material, this state being produced by cooling. Only once the component parts to be contacted are in position is it therefore possible for the electrically conductive material to adopt its liquid or pasty state. This thus also assists the fact that, during the production process of the chip card, the electrically conductive material is prevented from flowing away or becoming removed from the actual target location.

In accordance with an embodiment of the invention, the method further comprises the step of shaking the applied material. A corresponding shaking device can be used for this purpose. The shaking ensures that the electrically conductive material, in particular before the second electrical component part of the chip card is brought into contact, assumes a droplet form for example on the side facing towards the second electrical component part, or at least the side of the electrically conductive material pointing away from the first electrical component part assumes a homogeneous smooth surface structure. If, specifically, the material for example is volumetrically metered into the above-described recess, a type of “lobe” could thus form at the needle removal point of the material after the removal of the needle used for the volumetric metering. If the second electrical component part (the contact area thereof) were now applied directly to this lobe, a non-uniform contacting could thus be produced.

It is also conceivable however, in particular after the application of the electrically conductive material, for the electrically conductive material to be measured optically. For example, the electrically conductive material may protrude to a certain extent from said recess in a direction pointing away from the first electrical component part. The extent to which the material protrudes from the recess is a measure for the applied quantity of conductive material. Due to the optical measurement, it is thus possible to monitor whether sufficient material has been introduced. If, by contrast, the “lobe” is present, said optical measurement is thus inaccurate. Due to the mechanical shaking process, the formation of a homogeneous smooth surface, of a convex surface or even of a spherical surface is initiated however due to the cohesion of the material. This makes it possible to carry out said optical measurement in a reproducible manner.

In accordance with an embodiment of the invention, the method further comprises the step of pre-treating the first and/or the second electrical component part and/or the recess. This could have the advantage that the adhesion of the conductive material to the first and/or second electrical component part and/or to the recess is promoted selectively. On the one hand, this could promote the contacting between component part and conductive material. On the other hand, this could ensure that, with a quick transport process of the card body during the production procedure from one processing station of the production machine used to the next processing station, there is no material loss of the conductive material due to the moment of inertia thereof. This is because the card is accelerated very quickly during the transport process in order to be transported to the next station.

In accordance with an embodiment of the invention, the pre-treatment comprises
selective heating of the first and/or of the second electrical component part and/or of the recess and/or of the conductive material and/or
treatment of the first and/or of the second electrical component part and/or of the recess and/or of the conductive material with a plasma and/or
application of a wetting agent to the first and/or second electrical component part and/or the recess and/or the conductive material.

In particular due to the heating, for example a selective heating of the first and/or the second electrical component part and/or of the recess and/or of the conductive material, the advantage could be provided that the adhesion of material and/or contact is improved hereby in a simple manner.

Due to the use of a plasma, for example an atmospheric plasma, the same effect could be produced, wherein, here, the surface properties of the materials, in particular of the base of the recess, which carries the first electrical component part, could additionally be optimised. The use of wetting agents could significantly improve the flow properties for adhesion of the electrically conductive material over the greatest area possible. Due to plasma treatment and/or the use of wetting agents, the base of the recess is wetted more quickly and there is an improved bonding of the electrically conductive material on the base. With the described transport process, the likelihood of an undesirable detachment of the electrically conductive material from the base is minimised.

The contactings by means of said metal or the metal alloy have a high ageing resistance, and contact areas formed in particular from a material that is hardly resistant to oxidation, such as copper, are also protected by the metal alloy against oxidation and corrosion. Such a contacting is also very stable within a very wide temperature range due to the nature of the electrically conductive material used. The chip cards can thus be stored and used in an unrestricted manner at practically all ambient temperatures.

It is generally noted that a metal alloy that in particular is non-toxic is preferably used as an electrically conductive material. The advantage, in particular compared to contact means containing solvents, that chip cards can be produced in an environmentally friendly manner without the risk of damaging the environment or the individuals involved in the production method can thus also be achieved. The health of users is also not compromised.

The described method can be applied for example to chip cards comprising at least one electronic component or to an electronic component part such as a chip module, a sensor, a battery, a switch, an antenna, a display or the like, wherein the contacts of various electrical components or component parts or various contacts of the same electrical component parts or of the same electrical component part are to be electrically conductively connected to one another. In this case, the method can be used in particular with what are known as dual-interface chip cards (DICs) for production of an electrically conductive connection between a chip module and an RFID antenna (or comparable antenna for contactless communication). Generally however, elements of which the function is limited exclusively to the electrical conductivity (for example contacting of the electrical connection elements, conductive tracks, antenna bridges or the like) and also elements that, in addition to an electrically conductive connection, provide further functions, for example switches, circuits, antennas, safety mechanisms or the like, can be formed by means of the described method.

What are known as dual-interface chip cards (DICs) are chip cards that are formed with a contact-based and also a contactless data transmission interface, which are both controlled by the same chip module. The method can also be used however for what are known as hybrid chip cards, that is to say chip cards having a contact-based and also a contactless data transmission interface, which are both controlled by their own chip module. The method for producing contactless chip cards can also be used with a contactless data transmission interface. In any case, it is necessary to produce an electrical connection between the used antenna and the chip module by means of corresponding connection techniques. Here, the aforementioned electrically conductive material can be used.

It is noted that the above-described embodiments of the invention can be combined arbitrarily provided the combined embodiments are not mutually exclusive.

Preferred embodiments of the invention will be explained in greater detail hereinafter on the basis of the drawings, in which:

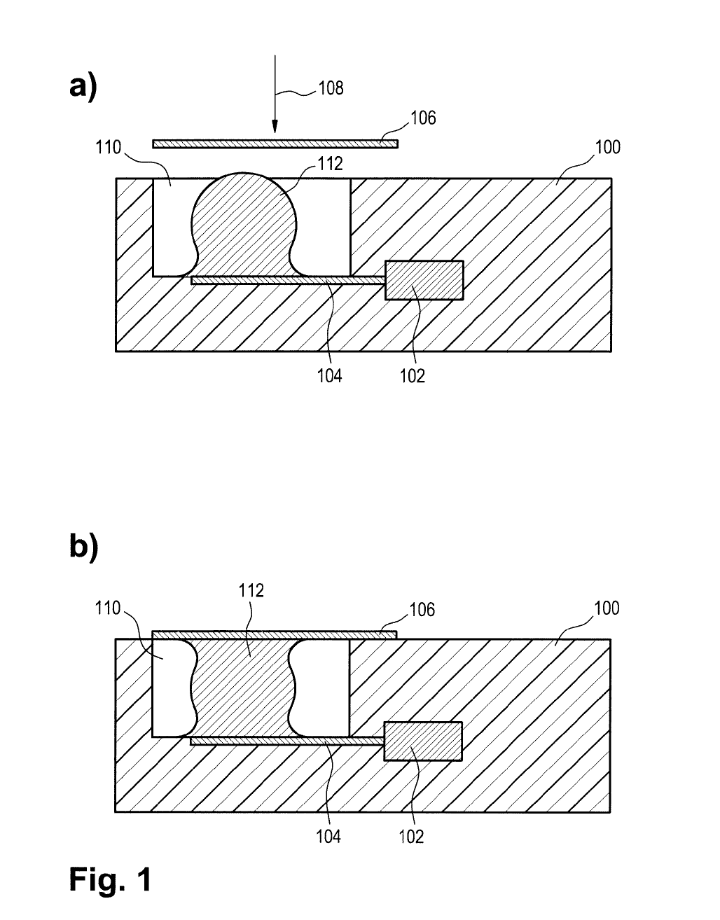

FIG. 1 shows cross-sectional views of a chip card,

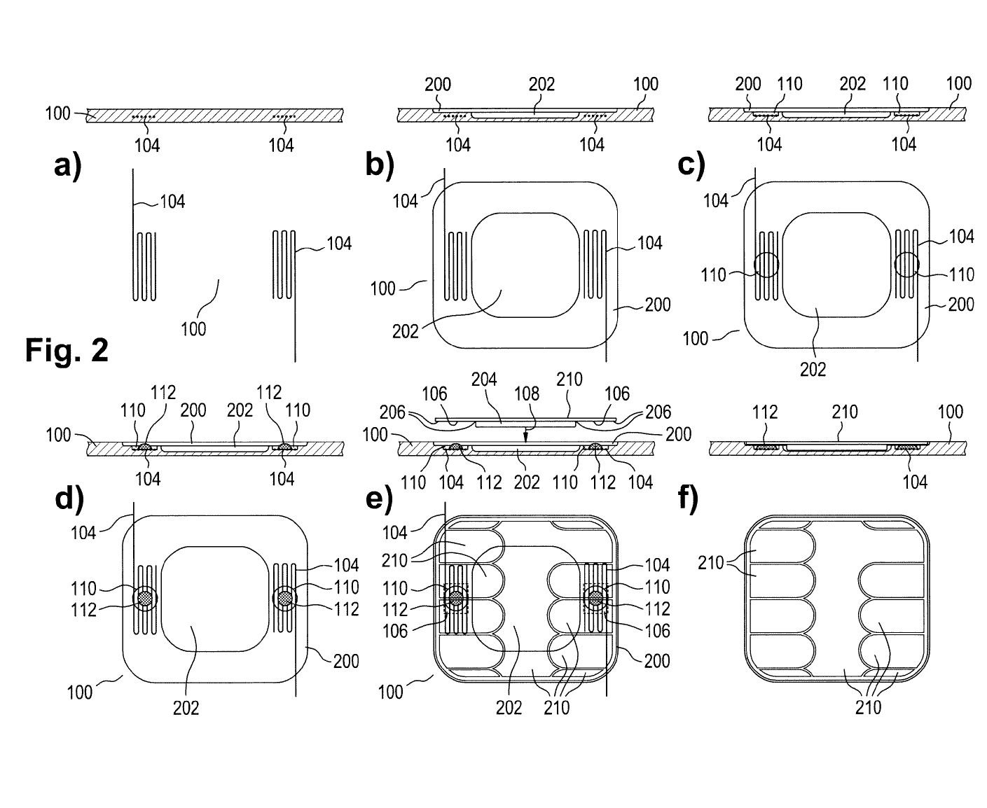

FIG. 2 shows various method steps for producing a chip card.

Similar elements will be denoted hereinafter by like reference signs.

FIG. 1 shows a schematic overview of manufacturing steps for producing the above-described chip card. Initially, the card body 100 can be seen, in which the first electrical component part 102 with its electrical contact 104, is already embedded, for example due to a lamination process. The card body 100 further comprises the recess 110, in which an electrically conductive material 112 is located. The electrically conductive material is pasty or liquid at room temperature.

Furthermore, a contact of a second electrical component part can be seen in FIG. 1a, wherein the contact is denoted by the reference sign 106. Due to a movement in direction 108, that is to say a movement perpendicular to the surface of the card body 100, the contact area 106 in FIG. 1a is applied to the electrically conductive material 112.

In particular in the case of a liquid state of matter of the electrically conductive material 112, the electrically conductive material 112 adopts an approximately spherical shape on the side facing towards the contact area 106 due to cohesive forces after a corresponding shaking process of the card body 100. By contrast, on the side facing towards the contact area 104, the contact area 104 has been wetted by the material 112 due to adhesive forces between the contact area 104 and the material 112.

The result shown in FIG. 1b can be seen that an electrical connection is now produced between the contact 106 and the contact 104 via the electrically conductive material. Due to the placement of the contact area 106 in direction 108, the electrically conductive material has experienced a deformation, such that an ellipsis shape has been formed from the original spherical shape. In addition, the contact area 106 has now likewise been wetted by the material 112 on the side facing toward the contact area 106 due to adhesive forces between the contact area 106 and the material 112.

Since the electrically conductive material 112 does not completely fill the recess 110 in FIG. 1a, the material is able to spread in the longitudinal direction of the recess, that is to say in FIG. 1b to the left and to the right in the direction of the short edge of the card body 100. An elongate form with a longitudinal extension in the direction parallel to the short side of the card body 100 is thus produced.

If, in FIG. 1b, a force were now to act in direction 108 due to an external mechanical influence, this would cause a slight deformation of the contact 106 and possibly also of the card body 100. This has no influence however on the electrical contact between the contact area 106 and the contact area 104, since, due to its liquid or pasty consistency, the electrically conductive material 112 can adapt without fatigue to a corresponding deformation of the contact area 106 and/or of the card body 100.

The material 112 can therefore avoid the force effect and the mechanical deformation so to speak and for example can enlarge its ellipsis shape in FIG. 1b to the left and to the right.

It is also advantageous that, should the contact areas 104 and 106 move away from one another, the electrical contact between these two contact areas is likewise maintained. If, for example, the contact area 106 thus lifts slightly against the direction 108 on the card body 100, a type of “hourglass effect” of the material 112 for example could be produced, wherein the waist of the droplet 112 becomes slimmer due to the lifting of the contact area. Conceivable causes here of the lifting of the area 106 include, for example, mechanical influences in the range from 50-100 μm for example, by which the contact area 106 could lift from the card body.

Even in the case of severe heating of the card body 100, for example when the chip card 100 is left on a warm surface, such as a heater, over a specific period of time, the electrically conductive material 112 may experience a thermal expansion without any mechanical influence of the contacts 104 and 106. The recess 110 provides sufficient space for this purpose.

In all described cases of the change to the shape of the electrically conductive material 112, it is ensured, due to adhesion between the material 112 and the contacts 106 or 104, that the electrical contact remains well maintained in an unchanged form.

It can thus be summarised that a metal that is liquid or pasty at room temperature or a metal alloy that is liquid or pasty at room temperature is used in FIG. 1. This is initially applied by means of a suitable application method, for example by means of volumetric dispensing onto the contact area 104, sunken in the card body 100, of the component part 102 recessed into the card body, for example an antenna. In a further process step, the further electrical component part, for example a chip module, is then introduced or applied via its contact 106 into or onto the chip card body. The contact area 106 thus comes into contact with the metal alloy or the metal 112, whereby said material bonds adhesively to the contact areas.

With the aid of the described method, two adhesively bonding connections can thus be produced for each electrically conductive connection, specifically one between the electrically conductive material and the contact area of the first electrical component part embedded in the chip card body, and one between the electrically conductive material and the contact area 106. It is noted that, within the scope of the entire description including the claims, there is generally the possibility beyond an adhesive bond to produce an “alloying” (for example formation of intermetallic phases or compounds), in particular due to a specific selection of a suitable metal alloy in accordance with the composition thereof and the composition of the contact areas. This alloying of the alloy into the contact areas may lead to a new phase formation, whereby for example the electrical contacting is further improved. An electrically very effectively conductive and maximally ageing-resistant connection between said electrical component parts could thus be achieved and is similar even to a soldered connection in terms of its quality.

It is also noted that, generally within the scope of the entire description including the claims, said metal alloy originates from a complex alloy system involving for example tin, bismuth, gallium, indium, rhodium, silver and zinc. This list should not be interpreted as being conclusive however.

FIG. 2 shows a schematic overview of various method steps for producing a chip card.

A cross-sectional view through the card body 100 and a plan view of the card body 100 are shown in FIG. 2 for each method step. The method starts in FIG. 2a with the provision of a card body 100, in which the contact area 104 is embedded. For example, the contact area 104 is part of an antenna. As can be seen, the contact area 104 is meandering. The likelihood of good contacting with the electrically conductive material is thus increased—the meaning of this will be better understandable later in particular with regard to FIGS. 2c and 2d.

In FIG. 2b, two different recesses are first produced. On the one hand, this is the recess 202 that constitutes an indentation for receiving the chip module to be applied. In the embodiment in FIG. 2, it is therefore generally assumed without restriction that the second electrical component part to be contacted is what is known as a chip module. The further indentation 200 is used primarily for the purpose of providing a glued area, via which, at the end of the method (FIG. 2f), the chip module can be permanently connected to the card body 100.

Once the recesses 200 and 202 have been produced, the recess 110 is produced in FIG. 2c, for example by milling. The milling procedure takes place here in the region of the adhesive area (indentation 200) of the chip module to be applied and above the meandering contact region 104. The underlying meandering contact region can be seen through the recess 110 in the plan view of the card body in FIG. 2c:

In FIG. 2d it can be seen that, in a further method step, the electrically conductive material is introduced into the recess 110. Due to the meandering contact loop 104, it is now ensured that at least one of the windings of the meander is electrically connected to the electrically conductive material 112 with a high level of probability. Even with inaccurate milling of the recess 110 in the step in FIG. 2c, it would thus be ensured that a good contacting between the contact 104 and the electrically conductive material 112 can be achieved with a high level of probability.

Lastly, in FIG. 2e, the chip module is introduced and is denoted hereinafter by reference sign 204. The chip module, besides an upper face 210, also comprises contact areas 106. These may likewise be meandering. An electrical connection is to be produced between these contact areas 106 and the contact 104 via the electrically conductive material 110. To this end, the chip module 204 is fitted onto the card body 100 in the direction 108. The glued areas 206 of the chip module 204 surrounding the contact areas 106 laterally are also used to seal the recess 110 with respect to moisture. To this end, the glued area 206 comes into contact with the glued area 200. By means of a corresponding gluing process, as can be seen in FIG. 2f, the electrically conductive material 112 is then fully enclosed in the recess 110. To this end, the glued area 206 fully surrounds the contact area 106. For example, the glued area 206 fully surrounds the recess 110.

As a result, the chip card as can be seen in FIG. 2f is produced. On its upper face, the chip card comprises further contact areas 210 of the chip module 204.

To summarise, it is noted that the electrically conductive material can be introduced cost effectively into the recess 110, for example by dispensing. No thermal energy has to be supplied in order to activate the material, and, in addition, the electrically conductive material has a conductivity that is normally greater than the conductive adhesives. Furthermore, in accordance with the method described generally, there is no need for a waiting period until the applied material has cross-linked or cured, and therefore the chip module for example can be introduced into the card body within the production process directly after the application of the metal or of the metal alloy. For example, the output of the process can thus increase.

### LIST OF REFERENCE SIGNS

100 card body
102 first electrical component part
104 contact
106 contact
108 direction
110 recess
112 electrically conductive material
200 recess
202 recess
204 chip module
206 adhesive area
210 contact area

1. A chip card, comprising a first electrical component part and a second electrical component part, wherein the first electrical component part and the second electrical component part are coupled with one another via an electrically conductive material, wherein the electrically conductive material comprises a metal or a metal alloy, wherein the metal or the metal alloy is pasty or liquid at room temperature.

2. The chip card according to claim 1, wherein the chip card comprises a card body, wherein the electrically conductive material is enclosed by at least one of the card body, the first electrical component part, and the second electrical component part.

3. The chip card according to claim 2, wherein the enclosure results at least in part from an adhesive bond.

4. The chip card according to claim 2, wherein the card body comprises a recess, wherein the electrically conductive material is received at least in part in the recess and the first electrical component part and the second electrical component part are arranged facing towards one another on mutually opposed sides of the recess.

5. The chip card according to claim 4, wherein, in the contacted state of the first electrical component part and of the second electrical component part, the recess is filled incompletely with the electrically conductive material.

6. The chip card according to claim 5, wherein the recess has a slot shape.

7. The chip card according to claim 1, wherein the electrically conductive material is free of organic compounds.

8. The chip card according to claim 1, wherein at least one of the first electrical component part and the second electrical component part has a meandering contact region, wherein the coupling between the first electrical component part and the second electrical component part is produced via the contact region.

9. The chip card according to claim 1, wherein at least one of the first electrical component part and the second electrical component part comprises a chip module or a conductive track or an antenna or a switch or a display or a battery or a sensor.

10. The chip card according to claim 1, wherein, in the coupled state, the coupling between the first electrical component part and the second electrical component part results from an adhesion of the electrically conductive material to the first electrical component part and the second electrical component part.

11. A method for producing a chip card, said method comprising:
providing a first electrical component part in a chip card body;
applying an electrically conductive material on the first electrical component part, wherein the electrically conductive material comprises a metal or a metal alloy, wherein the metal or the metal alloy is pasty or liquid at room temperature; and
bringing a second electrical component part into contact with the electrically conductive material.

12. The method according to claim 11, further comprising enclosure of the electrically conductive material.

13. The method according to claim 11, wherein the electrically conductive material is applied via at least one of
volumetric metering,
a printing method, and
provision of a carrier comprising at least one recess, wherein the recess comprises the material, wherein the carrier is applied to the first electrical component part.

14. The method according to claim 13, wherein the first electrical component part of the chip card is provided with the card body, wherein the method further comprises a production of a recess in the card body, wherein the volumetric metering comprises a metering of the material into the recess.

15. The method according to claim 11, wherein the electrically conductive material is applied in a solid state of matter of the material, said state being produced by cooling.

16. The method according to claim 15, wherein the second electrical component part is brought into contact with the electrically conductive material in the solid state of matter of the material produced by cooling.

17. The method according to claim 11, further comprising the step of shaking the applied material.

18. The method according to claim 11, further comprising pretreating at least one of the first electrical component part, the second electrical component part, the recess, and the material.

19. The method according to claim 18, wherein the pre-treatment comprises at least one of:
a heating of at least one of the first electrical component part, the second electrical component part, the recess, and of the conductive material;
a treatment of at least one of the first electrical component part, the second electrical component part, the recess with a plasma, and the conductive material; and
an application of a wetting agent to at least one of the first electrical component part, the second electrical component part, the recess, and the conductive material.

20. The chip card according to claim 1, wherein the electrically conductive material is a metal alloy including at least one material selected from the group consisting of tin, bismuth, gallium, indium, rhodium, silver, and zinc.
